(19) United States
(12) Patent Application Publication
(10) Pub. No.: US 2011/0181745 A1
(43) Pub. Date: Jul. 28, 2011

(54) PRESENTATION SYSTEM

(75) Inventors: Hiroshi Nagatsuma, Nagoya (JP); Yasuo Masui, Miyoshi (JP)

(73) Assignee: ELMO COMPANY, LIMITED, Mizuho-ku (JP)

(21) Appl. No.: 12/945,009

(22) Filed: Nov. 12, 2010

(30) Foreign Application Priority Data
Jan. 27, 2010 (JP) 2010-15032

(51) Int. Cl. H04N 5/225

(52) U.S. Cl. 348/220.1; 348/E05.024

(57) ABSTRACT

The presentation device comprises an image capture portion for capturing an image, and a transmission portion for wireless serial transmission of the captured images. The image output device comprises a reception portion for wireless serial reception of the images from the presentation device, an output portion for outputting the received images, and a measurement portion for measuring wireless signal strength. The output portion compares the signal strength with a threshold value established through an operation by the user, and if the signal strength exceeds the threshold value, serially outputs the images serially received by the reception portion so as to outputs a moving image, or if signal strength is equal to or less than the threshold value, continuously outputs a single previously received image so as to outputs a still image.

### RELATED APPLICATIONS

This application claims priority from Japanese Patent Application No. 2010-15032, filed Jan. 27, 2010, which is herein incorporated by reference in its entirety for all purposes.

### FIELD OF THE INVENTION

The present invention relates to a system for outputting images captured by a presentation device.

### BACKGROUND OF THE INVENTION

Recently, technologies for wirelessly transmitting and displaying images captured by a presentation device to an external image output device have been proposed (see JP-A-1998-262163 and JP-A-2008-271265 for example).

However, wireless communications sometimes experience fluctuations in signal strength or connection status caused by signal interference, the presence of obstacles, or the like. Fluctuations in signal strength or connection status may result in unstable display of output image, such as noise produced in the displayed image or sudden blackout of the image.

### SUMMARY OF THE INVENTION

An object of the present invention is to provide a technique for use in a system for wireless transmission of images captured by a presentation device to an external image output device, whereby it is possible to perform settings reflecting user preferences in relation to stability of the output image.

According to an aspect of the invention there is provided a presentation system in which a presentation device and an image output device connect wirelessly. the presentation device comprises an image capture portion for capturing an image; and a transmission portion for wireless serial transmission of images captured by the image capture portion; the image output device comprises a reception portion for wireless serial reception of the images from the presentation device; an output portion for outputting images received by the reception portion; and a measurement portion for measuring the wireless signal strength; wherein the output portion compares the signal strength with a threshold value set by an operation performed by a user, and if the signal strength exceeds the threshold value, serially outputs the images serially received by the reception portion so as to output a moving image, or if signal strength is equal to or less than the threshold value, continuously outputs a single previously received image so as to output a still image.

According to the presentation system having the above feature, signal strength measured by the presentation device is compared with a threshold value set by an operation performed by the user, and if the signal strength exceeds the threshold value a moving image is output, whereas if the signal strength is equal to or less than the threshold value a still image is output. Thus, for example, where a high threshold value is set, even if signal strength decreases, a still image with minimal noise that was received under good connection conditions can be output; or where a low threshold value is set, it is possible to assign priority to output of a moving image even if noise has occurred in the image due to poor signal strength. Thus, according to the presentation system having the above feature, it is possible to make settings that reflect user preferences in relation to stability of the output image.

In a preferable embodiment of the invention, the image output device further comprises a signal strength transmission portion for wirelessly transmitting to the presentation device signal strength information that represents the signal strength; and the presentation device further comprises a signal strength reception portion for wirelessly receiving the signal strength information from the image output device; and a signal strength display portion for producing a display relating to the signal strength on the basis of the received signal strength information.

According to this feature, a display relating to signal strength measured by the presentation device is provided on the presentation device end, where the user actually carries out the operations. It is possible to improve convenience for the user thereby.

Further embodiments of the invention may provide a method of controlling a presentation system, or a computer program for controlling a presentation system. The computer program may be recorded on a computer-readable recording medium. The recording medium could be a flexible disk, a CD-ROM, a DVD-ROM, a magneto-optical disk, a memory card, a hard disk, or any of various other media for example.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an illustration of the general features of a presentation system, according to an embodiment of the invention;

FIG. 2 is a block diagram depicting the internal configuration of a presentation device, according to an embodiment of the invention;

FIG. 3 is a block diagram depicting the internal configuration of an image output device, according to an embodiment of the invention;

FIG. 4 is a flowchart of an image output process, according to an embodiment of the invention; and

FIG. 5 is an illustration showing an example of a display containing synthesized signal strength information.

### DETAILED DESCRIPTION

A. General Features of Presentation System.

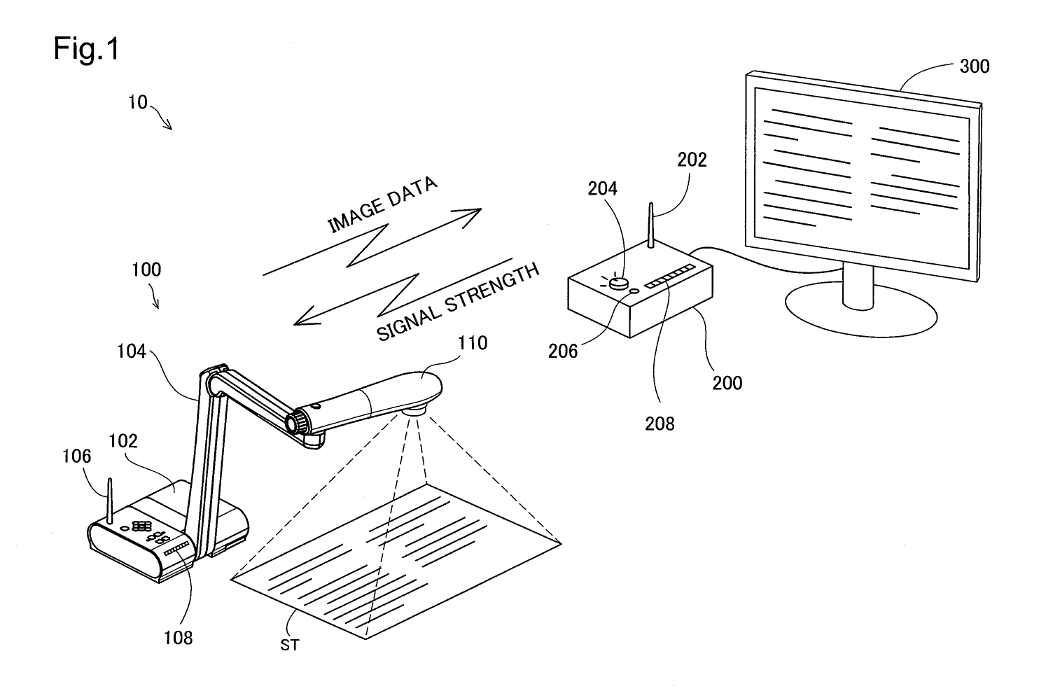

FIG. 1 is an illustration of the general features of a presentation system 10, according to an embodiment of the present invention. The presentation system 10 may include a presentation device 100, an image output device 200, and an external display device 300. A liquid crystal display, a projector, a TV monitor or the like could be employed as the external display device 300 for example. The presentation device 100 of the present embodiment has a function of wirelessly transmitting an image of a subject ST captured by a camera head 110 to the image output device 200. When the image output device 200 receives the image wirelessly from the presentation device 100, it then outputs this image to the external display device 300 via an analog RGB interface.

The presentation device 100 comprises a base 102 adapted to be placed on a surface such as a desktop, a support post 104 that extends upward from the base 102, and a camera head 110 mounted to the distal end of the support post 104 for capturing an image of the subject ST. The base 102 is also provided with an antenna 106 for wireless communication with the image output device 200. The antenna 106 may be disposed so as to lie exposed to the outside, or disposed within the base 102 or the support post 104. The base 102 is additionally provided with a signal strength display 108 for displaying the signal strength during wireless communication. The signal strength display 108 has eight light emitting diodes; when the device is connected wirelessly, the signal strength is displayed in eight levels, or if the wireless connection is disconnected, the light emitting diodes all turn off. The signal strength display 108 is not limited to this particular form, and values representing signal strength could be displayed as-is by a seven-segment display for example.

The image output device 200 has an antenna 202 for the purpose of communicating wirelessly with the presentation device 100, an operating mode selection switch 204, a signal strength display switch 206, and a signal strength display portion 208. The operating mode selection switch 204 is a switch allowing to user to make settings in relation to stability of the output image in accordance with his or her preference. The signal strength display switch 206 is a switch for bringing up a display of signal strength level overlaying the output image. The signal strength display portion 208, like the signal strength display portion 108 of the presentation device 100, has eight light emitting diodes, and displays the signal strength in eight levels.

B. Internal Configuration of Presentation Device.

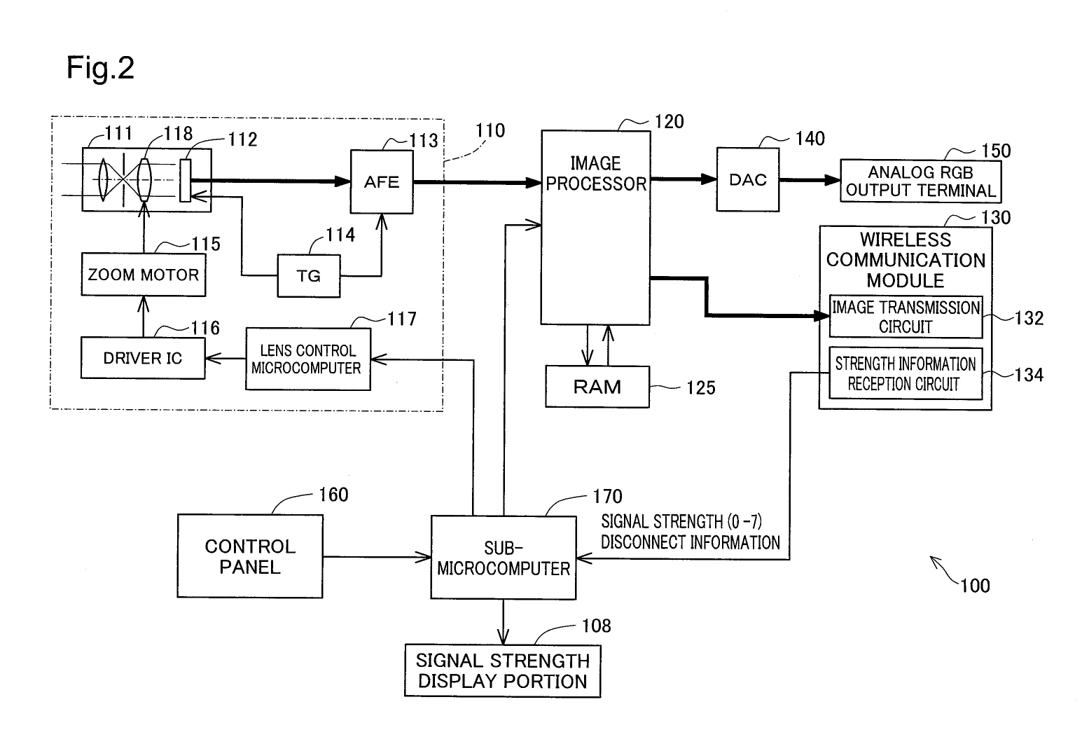

FIG. 2 is a block diagram depicting the internal configuration of the presentation device 100, according to an embodiment of the invention. As illustrated, the presentation device 100 may have a camera head 110, an image processor 120, a RAM 125, a wireless communication module 130, a DAC 140, an analog RGB output terminal 150, a control panel 160, a sub-microcomputer 170, and a signal strength display portion 108.

The camera head 110 comprises a lens unit 111 for capturing an image of the subject ST, a CCD image sensor 112 for converting the light collected by the lens unit 111 to an electrical signal, an analog front end 113 for converting the analog signal output by the CCD image sensor 112 to a digital signal, and a timing generator 114 for outputting a reference pulse for the purposes of operation of the CCD image sensor 112 and the analog front end 113. It would be possible to employ a CMOS image sensor in place of the CCD image sensor 112.

The lens unit 111 is composed of several lenses, and comprises a zoom lens 118. Inside the camera head 110 there are provided a zoom motor 115 for moving the zoom lens 118 towards the telephoto end or the wide angle end, and a driver IC 116 for driving the zoom motor 115. The driver IC 116 is connected to a lens control microcomputer 117; zoom direction and zoom speed are controlled by adjusting the frequency or voltage of a signal that is output to the zoom motor 115 in response to an instruction from the lens control microcomputer 117.

The picture signal output by the analog front end 113 is input to the image processor 120. The image process acquires the image from the analog front end 113 and temporarily stores it in the RAM 125. Using the RAM 125 as the working area, it then performs various image processes on the acquired image. Examples of image processes performed by the image processor 120 include white balance adjustment, gamma correction, edge sharpening, and so on. The image data having undergone image processing by the image processor 120 is serially output at a prescribed frame rate (e.g. 30 frames per second) to the wireless communication module 130. The image data output to the wireless communication module 130 by the image processor is uncompressed data of XGA (1024×768 pixels) resolution for example, containing data of 24 bits (8 bits each for R, G, and B, for a total of 24 bits) on each pixel.

The wireless communication module 130 is a hardware module incorporating a microcomputer and wireless communication IC. The wireless communication module of the present embodiment communicates with the image output device 200 on the basis of the wireless communications standard known as WHDI (Trademark) (Wireless Home Digital Interface). However, a different standard besides WHDI, such as Wireless HD (Trademark), IEEE 802.11g or n, or some other wireless LAN standard could be selected as the wireless communications standard instead.

The wireless communication module 130 comprises an image transmission circuit 132 and a strength information reception circuit 134. The image transmission circuit 132 has the function of transmitting image data input from the image processor 120 to the image output device 200, based on the WHDI standard. The strength information reception circuit 134 has a function of wirelessly receiving from the image output device 200 information that represents signal strength (herein termed “signal strength information”) and a function of detecting the connection status of wireless communication between the presentation device 100 and the image output device 200. If the presentation device 100 and the image output device 200 are wirelessly connected, the strength information reception circuit 134 receives, from the image output device 200, signal strength information ranging from “0” to “7”. The strength information reception circuit 134 then outputs the signal strength information thusly received from the image output device 200 to the sub-microcomputer 170, discussed later. If the strength information reception circuit 134 detects that the wireless connection is not connected, it outputs to the sub-microcomputer 170 disconnect information indicating that the wireless connection is not connected.

Besides the wireless communication module 130, the DAC 140 is also connected to the image processor 120. The image processor 120 outputs a digital signal representing the image-processed image to the DAC 140. The DAC 140 performs D/A conversion of the digital signal and generates an analog RGB signal. The analog RGB signal so generated is output to the analog RGB output terminal 150. That is, in addition to its function of transmitting images wirelessly, the presentation device 100 of the present embodiment is able to output images to an external display device directly connected to the presentation device 100 via the analog RGB output terminal 150. The presentation device 100 may be provided with additional outputs besides the analog RGB output terminal 150, such as a DVI output terminal, video output terminal, or HDMI output terminal for example.

The control panel 160 is provided on the base 102 of the presentation device 100. The control panel 160 is provided for example with a zoom button for optical zoom of the camera head 110, and with buttons for selecting image processes to be carried out by the image processor 120. The sub-microcomputer 170 is connected to the control panel 160; the sub-microcomputer 170 receives input of various button operations from the control panel 160, and outputs to the image processor 120 and the lens control microcomputer 117 a signal associated with the particular button operation it receives.

The signal strength display portion 108 (see FIG. 1) is also connected to the sub-microcomputer 170. The sub-microcomputer 170 acquires signal strength information or disconnect information from the strength information reception circuit 134 in the wireless communication module 130, and on the basis of this information carries out control of lighting of the light emitting diodes which make up the signal strength display portion 108. For example, upon acquiring signal strength information, the sub-microcomputer 170 increases the number of light emitting diodes that are lit, in association with a greater numerical value. That is, if the signal strength information indicates a “0”, a single light emitting diode is lit, whereas if the signal strength information indicates a “7”, eight light emitting diodes are lit. If disconnect information is acquired, all of the light emitting diodes are turned off. Alternatively, in the event that disconnect information was acquired by the sub-microcomputer 170, it may flash all (or some) of the light emitting diodes in order to call the attention of the user.

C. Internal Configuration of Image Output Device.

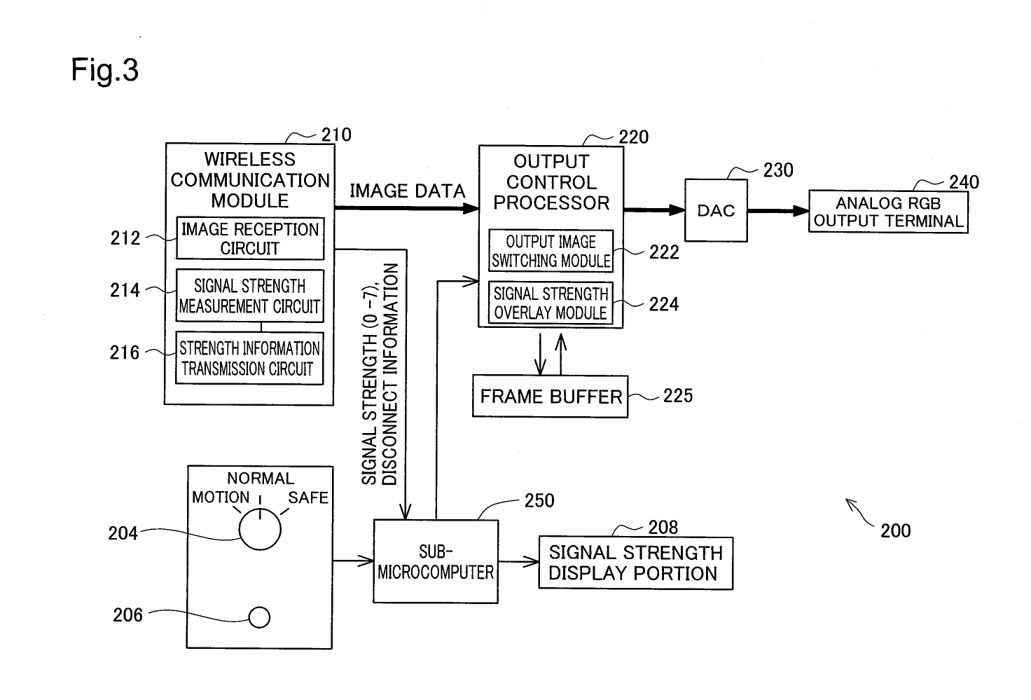

FIG. 3 is a block diagram depicting the internal configuration of the image output device 200, according to an embodiment of the invention. The image output device 200 may include a wireless communication module 210, an output control processor 220, a DAC 230, an analog RGB output terminal 240, and a signal strength display 208.

Like the wireless communication module 130 in the presentation device 100, the wireless communication module 210 may be a hardware module that incorporates a microcomputer and wireless communication IC, and communicates with the presentation device 100 via the antenna 202 on the basis of the WHDI standard.

The wireless communication module 210 has an image reception circuit 212, a signal strength measurement circuit 214, and a strength information transmission circuit 216. The image reception circuit 212 has the function of receiving image data sent from the presentation device 100, and transferring the received data to the output control processor 220. The signal strength measurement circuit 214 measures the signal strength and monitors wireless connection status. Where a wireless connection exists between the presentation device 100 and the image output device 200, the signal strength measurement circuit 214 represents the measured signal strength level with numerical values ranging from “0” to “7”. Of the values “0” to “7”, greater values represent greater signal strength. Signal strength information of “0” does not mean that the wireless connection is disconnected, but rather indicates that signal strength is at a minimum. The signal strength measurement circuit 214 outputs this signal strength information to the strength information transmission circuit 216 and the sub-microcomputer 250. If the signal strength measurement circuit 214 detects that the wireless connection was lost, it outputs disconnect information indicating that the wireless connection was lost, to the sub-microcomputer 250. The strength information transmission circuit 216 wirelessly communicates to the presentation device 100 the signal strength information that it acquired from the signal strength measurement circuit 214.

The output control processor 220 receives the image data transferred from the wireless communication module 210 and temporarily saves the received data to the frame buffer 225. The image data saved to the frame buffer 225 is read by the output control processor 220 at a prescribed frame rate (e.g. 60 frames per second) and is transferred to the DAC 230. In the DAC 230, the image signal representing the image data undergoes D/A conversion to generate an analog RGB signal. The analog RGB signal so generated is output to the external display device 300 through the analog RGB output terminal 240. The image output device 200 may be provided with additional outputs besides the analog RGB output terminal 240, such as a DVI output terminal, video output terminal, or HDMI output terminal for example.

The output control processor 220 has as internal function modules: an output image switching module 222, and a signal strength overlay module 224. The output image switching module 222 has the function of switching the image that is output to the external display device 300 between a moving image and a still image according to the signal strength measured by the wireless communication module 210, and the operating mode that was set by the user with the operating mode selection switch 204. The specifics of the process carried out by the output image switching module 222 are discussed in detail later. The signal strength overlay module 224 has the function of synthesizing signal strength information with the image data received from the wireless communication module 210, in the event that the signal strength display switch 206 has been turned on.

The operating mode selection switch 204 and the signal strength display switch 206 are connected to the sub-microcomputer 250. Through the sub-microcomputer 250, operations by the operating mode selection switch 204 and the signal strength display switch 206 are communicated to the output control processor 220. When the operating mode is set by the operating mode selection switch 204, the sub-microcomputer 250 communicates to the aforementioned output image switching module 222 of the output control processor 220 a numerical value (threshold value) associated with the selected operating mode. The sub-microcomputer 250 also transfers the signal strength information or disconnect information acquired from the wireless communication module 210 to the output control processor 220. The output image switching module 222 of the output control processor 220 compares the threshold value received from the sub-microcomputer 250 with the signal strength information, and switches the output image to either a moving image or a still image. According to the present embodiment, a “motion mode”, a “normal mode”, and a “safe mode” are provided as operating modes. When the operating mode is the motion mode, a threshold value of “0” is communicated to the output image switching module 222. When the device is set to normal mode a value of “2” is communicated, and when set to safe mode a value of “4” is communicated. In the present embodiment, the threshold value is switchable between three levels by the operating mode selection switch 204, but finer threshold value gradations would be possible as well.

The signal strength display 208 is also connected to the sub-microcomputer 250. The sub-microcomputer 250 acquires signal strength information or disconnect information from the wireless communication module 210, and on the basis of the information performs lighting control of the light emitting diodes that make up the signal strength display 208, in the same manner as the sub-microcomputer 170 of the presentation device 100.

D. Image Output Process.

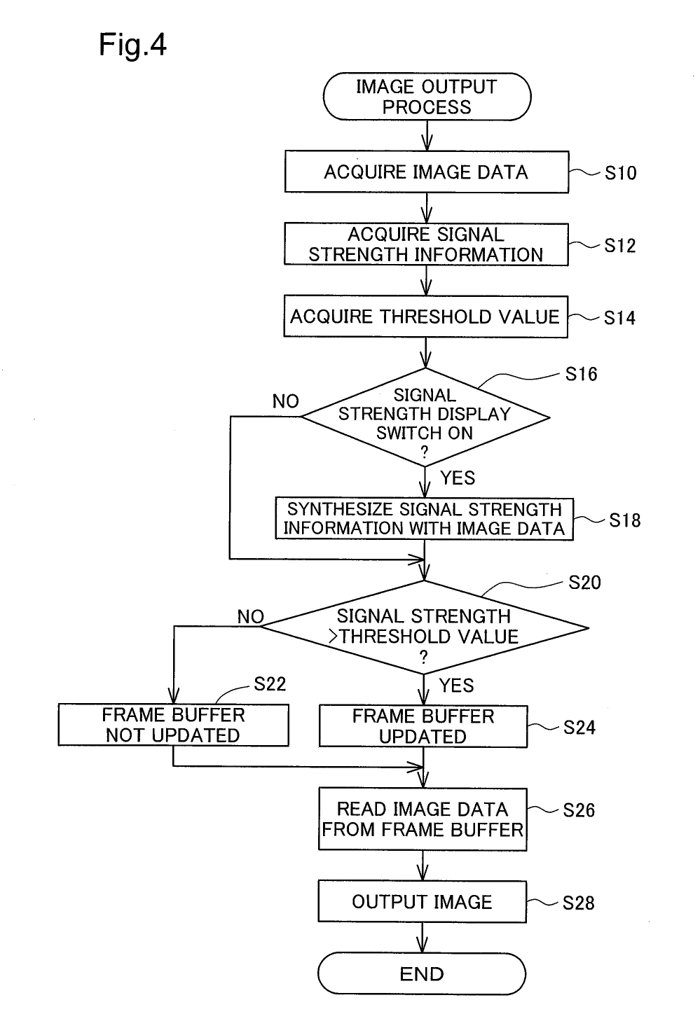

FIG. 4 is a flowchart of the image output process executed by the output control processor 220 of the image output device 200, according to an embodiment of the invention. This image output process may be executed repeatedly on an ongoing basis during operation of the image output device 200.

When this image output process is initiated, first, the output control processor 220 acquires from the image reception circuit 212 of the wireless communication module 210 the image data that was sent from the presentation device 100 (Step S10), and acquires either signal strength information or disconnect information from the signal strength measurement circuit 214 of the wireless communication module 210, via the sub-microcomputer 250 (Step S12). The output control processor 220 also acquires from the sub-microcomputer 250 a threshold value associated with the current setting of the operating mode selection switch 204 (Step S14).

Next, the output control processor 220, through the sub-microcomputer 250, determines whether the signal strength display switch 206 is on (Step S16). If the signal strength display switch 206 is on, the output control processor 220, using the signal strength overlay module 224, synthesizes the signal strength information with the image data that was acquired from the wireless communication module 210 (Step S18). On the other hand, if it determines that the signal strength display switch 206 is off, the output control processor 220 skips the synthesis process of Step S18 and does not carry out synthesis of signal strength information.

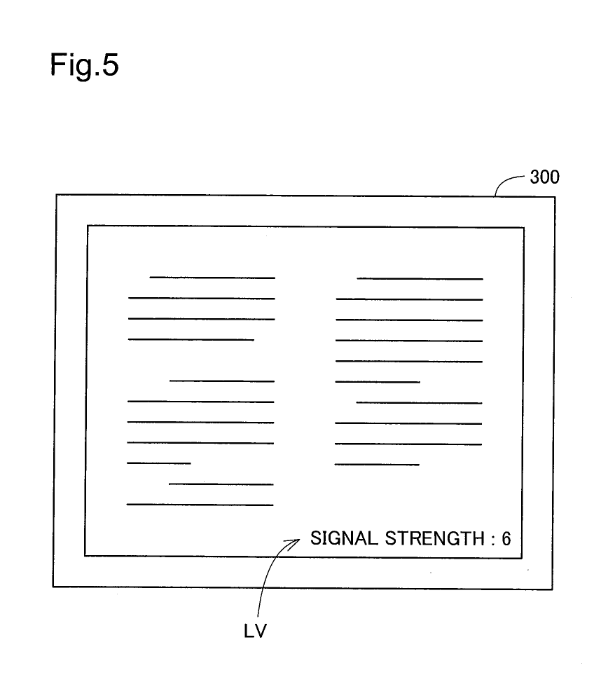

FIG. 5 is an illustration showing an example of signal strength information synthesized into the display on the screen of the external display device 300. In the example of FIG. 5, the numerical value LV of the signal strength information is simply displayed synthesized at the lower right of the screen. However, the signal strength display is not limited to such a numerical value, and it would be possible to employ a graphical display such as bars like those used to indicate signal strength in mobile phones, or some sort of scale or meter.

Next, the output control processor 220, using the output image switching module 222, compares the signal strength represented by the signal strength information that was acquired in Step S12 to the threshold value that was acquired in Step S14, and decides whether the signal strength exceeds the threshold value (Step S20). As mentioned previously, according to the present embodiment signal strength is represented by values of from “0” to “7”, and by switching of the operating mode selection switch 204 the threshold value is set to a value of either “0”, “2”, or “4”. If through this comparison it is determined that signal strength exceeds the threshold value, the output image switching module 222 rewrites the frame buffer 225 with the image data that was acquired in Step S10 (or with image data containing signal strength information synthesized in Step S18), to update the image data that was previously saved to the frame buffer 225 (Step S24). If on the other hand the signal strength is determined to be equal to or less than the threshold value, the output image switching module 222 suspends updating of the frame buffer 225 (Step S22). If updating of the frame buffer 225 is suspended, the image data that was already saved in the previous iteration of Step S24 remains held in the frame buffer 225. If disconnect information is acquired in Step S14, in Step S20 the output image switching module 222 decides that the signal strength is equal to or less than the threshold value.

Finally, the output control processor 220 reads out the image data from the frame buffer 225 at a prescribed frame rate (Step S26), and outputs the image represented by this data to the external display device 300 through the DAC 230 and the analog RGB output terminal 240 (Step S28). According to the image output process described above, if the current status is to update the frame buffer 225 contents (i.e. if signal strength exceeds the threshold value), a motion image is output to the external display device 300; whereas if updating of the frame buffer 225 contents has been suspended (i.e. if signal strength is equal to or less than the threshold value), a still image is output.

An embodiment of the presentation system 10 according to the present invention was described above. According to the presentation system 10 of the present embodiment, the threshold value that is compared with signal strength for the purpose of determining whether to output a moving image or a still image may be selected appropriately through the operating mode setting switch. It is accordingly possible to make settings relating to stability of the output image in a manner that reflects the preferences of the user.

For example, if the user sets the operating mode to “motion mode”, the threshold value is set to “0”, and thus up to the point that the wireless connection is lost, the image output device 200 outputs the image it receives from the presentation device 100, in the form of a moving image. It is thus possible to give priority to moving image output, even if the quality of the output image declines to poor reception conditions. As a result, it is possible for output to take place in a manner appropriate to a presentation of a subject involving motion.

On the other hand, if the operating mode is set to “safe mode”, the threshold value is set to “4”. In the present embodiment, the maximum value of signal strength is “7”, and thus where the system is set to safe mode, a still image is output from the image output device 200 relatively soon after signal strength becomes unstable. Thus, by setting the operating mode to safe mode, it is possible to output a high quality moving image or still image, based on an image received when the reception conditions are good. In this way, in “safe mode”, because the output image is switched from a moving image to a still image at a stage soon after signal strength becomes unstable, it is possible for output to take place in a manner appropriate to a presentation of a subject with minimal motion. By setting the operating mode to “normal mode”, it is possible to produce output having characteristics midway between those of “motion mode” and those of “safe mode”.

According to the presentation system 10 of the present embodiment, signal strength measured by the image output device 200 is communicated wirelessly to the presentation device 100 and is displayed on the signal strength display 108 provided to the presentation device 100. The user can thus ascertain reception conditions simply by looking at the presentation device 100 at hand. In the present embodiment, signal strength is also displayed on the signal strength display 208 provided to the image output device 200, and additionally signal strength may be displayed on the screen of the external display device 300, through operation of the signal strength display switch 206. It is accordingly possible to readily ascertain current reception conditions. The signal strength display 108 of the presentation device 100, the signal strength display 208 of the image output device 200, and the function of displaying signal strength on the screen are optional elements, and some or all of these may be dispensed with.

E. Further Embodiments.

While the present invention has been shown herein in terms of a preferred embodiment, no limitation of the invention to this particular embodiment is intended, and various other features may be employed without departing from the spirit thereof. Modifications such as the following are possible for example.

Modification 1.

In the preceding embodiment, the output image is switched from a moving image to a still image in the event of a decline in wireless signal strength. However, in a further embodiment, in response to a decline in signal strength communicated to it by the image output device 200, the image processor 120 of the presentation device 100 may drop the resolution, color depth, or frame rate of the data transferred to the image output device 200, according to the extent of the decline. By so doing it is possible to reduce the amount of data contained in the image data stream, so that moving image output may be maintained despite the decline in signal strength.

Modification 2.

In the preceding embodiment, the level of signal strength is displayed by the signal strength display 108 of the presentation device 100, by the signal strength display 208 of the image output device 200, or on the output screen. In an alternative arrangement however, a warning display may be brought up on the signal strength display 108, the signal strength display 208, or the screen, only in instances in which signal strength falls below a threshold value. This makes it possible to readily apprise the user of a drop in signal strength through a simple feature.

Modification 3.

In the preceding embodiment, the operating mode selection switch 204 provided to the image output device 200 is used to select the operating mode. However, in a further embodiment, an operating mode selection switch could be provided on the presentation device 100 end instead. In this case, a selection operation made with the operating mode selection switch is detected by the sub-microcomputer 170, and a threshold value associated with a selected mode is sent to the image output device 200 by the wireless communication module 130. According to this feature, the operating mode may be set at the presentation device 100 end, thus affording improved convenience for the user.

Modification 4.

In the preceding embodiment, the image output device 200 and the external display device 300 are provided as separate devices. In a further embodiment, however, the image output device 200 could be incorporated into the external display device 300. The wireless communication module 130 provided in the presentation device 100 may be separated from the presentation device 100 and provided as a separate image transmission device. In this case, the image signal from the presentation device 100 would be input to the image transmission device through an analog RGB interface or DIV interface for example. The image transmission device would then transmit wirelessly to the image output device 200 the image signal that was input from the presentation device 100.

Modification 5.

In the preceding embodiment, the image output device 200 uses the output control processor 220 to decide whether to make the output image a moving image or a still image. In a further embodiment, however, this decision could be made on the sub-microcomputer 250 end instead. In this case, the results of the determination by the sub-microcomputer 250 would be communicated to the output control processor 220, which would on that basis then determine whether to update the frame buffer 225.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A presentation system in which a presentation device and an image output device connect wirelessly, wherein
the presentation device comprises
an image capture portion for capturing an image; and
a transmission portion for wireless serial transmission of images captured by the image capture portion;
the image output device comprises
a reception portion for wireless serial reception of the images from the presentation device;
an output portion for outputting images received by the reception portion; and
a measurement portion for measuring wireless signal strength;
wherein the output portion compares the signal strength with a threshold value set by an operation performed by a user, and if the signal strength exceeds the threshold value, serially outputs the images serially received by the reception portion so as to output a moving image, or if signal strength is equal to or less than the threshold value, continuously outputs a single previously received image so as to output a still image.

2. The presentation system according to claim 1, wherein
the image output device further comprises a signal strength transmission portion for wirelessly transmitting to the presentation device signal strength information that represents the signal strength; and
the presentation device further comprises a signal strength reception portion for wirelessly receiving the signal strength information from the image output device; and a signal strength display portion for producing a display relating to the signal strength on the basis of the received signal strength information.
